(19) United States
(12) Patent Application Publication
(10) Pub. No.: US 2007/0062036 A1
(43) Pub. Date: Mar. 22, 2007

(54) METHOD OF FILLING AND SEALING WORKING FLUID WITHIN HEAT-DISSIPATING DEVICE

(76) Inventors: Chao-Nien Tung, Shenzhen (CN); Chih-Hao Yang, Shenzhen (CN); Chuen-Shu Hou, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,541

(22) Filed: Feb. 13, 2006

(30) Foreign Application Priority Data
Sep. 20, 2005 (CN) 200510037444.3

(51) Int. Cl. B23P 21/00; B23P 19/00

(52) U.S. Cl. 29/890.032; 29/801; 29/773; 29/778

(57) ABSTRACT

A method (100) of filling and sealing a predetermined quantity of working fluid within a hollow metal casing (11) of a heat-dissipating device such as a heat pipe (10) or a vapor chamber-based heat spreader includes the following steps: (1) filling a working fluid (16) into the hollow metal casing through an open end (12) thereof until the hollow metal casing is full of the working fluid; (2) pumping a portion of the working fluid out of the hollow metal casing until the predetermined quantity of working fluid is left in the hollow metal casing; and (3) sealing the open end of the hollow metal casing. By this method, a vacuum condition is accordingly formed inside the heat pipe due to removal of the portion of the working fluid from the heat pipe and the air contained in the heat pipe is effectively removed.

### FIELD OF THE INVENTION

The present invention relates generally to heat-dissipating devices, and more particularly to a method of filling and sealing a predetermined quantity of working fluid within a heat-dissipating device such as a heat pipe or a vapor chamber-based heat spreader or the like.

### DESCRIPTION OF RELATED ART

Vapor chamber-based heat spreaders and heat pipes are highly efficient devices for dissipating heat from heat-generating components such as central processing units (CPUs) of computers. As a common characteristic, these heat-dissipating devices contain therein a small quantity of working fluid and are capable of dissipating a large amount of heat by using a phase change mechanism of the working fluid. Vapor chamber-based heat spreaders generally have a plate-type configuration and therefore are particularly advantageous in transferring heat from a concentrated heat source uniformly to a large heat-dissipating surface such as a large heat sink base. When a vapor chamber-based heat spreader is maintained in thermal contact with the heat source, the working fluid contained in the heat spreader vaporizes into vapor. The vapor then runs quickly to be full of an inner chamber defined in the heat spreader, and when the vapor comes into contact with the cooler heat sink base attached to the heat spreader, it releases its latent heat of vaporization to the heat sink base and then turns into condensate; thus, the working fluid transfers the heat of the concentrated heat source evenly to the large heat sink base. Thereafter, the condensate returns back to the contacting region between the heat source and the heat spreader for being available again for evaporation.

As with heat pipes, they generally have an elongated configuration and therefore are particularly advantageous in bringing heat from a heat source to a distant region where the heat is dissipated. A heat pipe generally consists of a vacuum casing defining a chamber, a wick structure lining an inner wall of the casing and a working fluid filled in the chamber. The heat pipe is vacuumed and then hermetically sealed. The heat pipe has an evaporating end for receiving heat from the heat source and a condensing end for releasing the heat absorbed by the evaporating end. As heat generated by the heat source is inputted into the heat pipe via its evaporating end, the working fluid contained therein absorbs the heat and turns into vapor. Due to the difference of vapor pressure between the two ends of the heat pipe, the generated vapor moves, with the heat being carried, towards the condensing end where the vapor is condensed into condensate after releasing the heat into ambient environment by, for example, fins thermally contacting the condensing end. Afterwards, the condensate resulted from the vapor in the condensing end is drawn back by the wick structure to the evaporating end where it is again available for evaporation. This continuous cycle transfers a large quantity of heat with a very low thermal gradient.

For transferring heat, the heat pipe is expected to have a low thermal resistance (R), which is affected by the maximum heat transfer capacity (Qmax) of the heat pipe and the temperature difference (ΔT) between the evaporating end and the condensing end of the heat pipe. The three parameters are related, based on the relationship: R=ΔT/Qmax. As can be seen from the equation, the thermal resistance (R) of the heat pipe decreases as the temperature difference (ΔT) between the two ends of the heat pipe decreases and the maximum heat transfer capacity (Qmax) of the heat pipe increases. Specifically, the parameters Qmax and ΔT of the heat pipe are closely related with the quantity of working fluid and the vacuum condition sealed within the heat pipe. The larger amount of working fluid the heat pipe contains, the higher maximum heat transfer capacity (Qmax) the heat pipe has. Meanwhile, a higher vacuum degree inside the heat pipe is helpful in lowering the temperature difference (ΔT) between the two ends of the heat pipe. A major factor affecting the vacuum degree inside the heat pipe is the amount of undesirable air retained in the heat pipe, including the air contained in the working fluid, the air retained in the pores of the wick structure and the air left in the chamber of the heat pipe.

A conventional method for sealing within a heat pipe with a predetermined amount of working fluid relates to the use of a vacuum pump to evacuate the heat pipe. Typically, a suction tube of the vacuum pump extends into an interior of the heat pipe through an open end thereof and the vacuum pump operates to extract the air contained in the heat pipe. Thereafter, the heat pipe is filled with the predetermined amount of working fluid and the open end of the heat pipe is sealed. However, by this method, the air contained in the heat pipe cannot be effectively extracted and removed. Ultimately, a certain amount of air will inevitably be still left within the heat pipe. Furthermore, the air retained in the pores of the wick structure arranged inside the heat pipe also cannot be sufficiently drawn out of the heat pipe by the vacuum pump. In addition, in most cases, the open end of the heat pipe is previously shrunk to have a diameter (typically about 2 millimeters), which is much smaller than that of the vacuum casing of the heat pipe, in order to facilitate sealing the heat pipe subsequently. In this situation, pumping the undesirable air out of the heat pipe becomes a time-consuming work. Meanwhile, it becomes more difficult to draw the air out of the heat pipe through such a narrow outlet.

Therefore, it is desirable to provide a method of filling and sealing a predetermined quantity of working fluid within a heat pipe (or a vapor chamber-based heat spreader or the like), which overcomes the foregoing disadvantages.

### SUMMARY OF INVENTION

The present invention relates to a method of filling and sealing a predetermined quantity of working fluid within a hollow metal casing of a heat-dissipating device. The method includes the following steps: (1) filling a working fluid into the hollow metal casing through an open end thereof until the hollow metal casing is full of the working fluid; (2) pumping a portion of the working fluid out of the hollow metal casing until the predetermined quantity of working fluid is left in the hollow metal casing; and (3) sealing the open end of the hollow metal casing.

In accordance with one aspect of the present method, the air contained in the working fluid is previously removed before the working fluid is filled into the hollow metal casing. In accordance with another aspect of the present method, a wick structure is disposed inside the hollow metal casing and the hollow metal casing is heated after the working fluid is filled into the hollow metal casing but before the portion of the working fluid is pumped out of the hollow metal casing, so as to remove the air retained in the pores of the wick structure.

In the present method, a vacuum condition is formed in the hollow metal casing, by pumping the originally filled working fluid out of the casing until the predetermined quantity of working fluid is left therein. The undesirable air originally contained in the heat pipe, including that in the working fluid and in the wick structure, is effectively removed.

Other advantages and novel features of the present invention will become more apparent from the following detailed description of preferred embodiment when taken in conjunction with the accompanying drawings, in which:

### BRIEF DESCRIPTION OF DRAWINGS

FIG. 1 is a flow chart showing a preferred method of the present invention used for filling and sealing a predetermined quantity of working fluid within a hollow metal casing of a heat-dissipating device;

FIG. 2 is a view illustrating a heat pipe which is being filled with a working fluid;

FIG. 3 is a graph illustrating the relationship between the temperature and the amount of air contained in water;

FIG. 4 is a view similar to FIG. 2, showing the heat pipe is being filled with the working fluid in accordance with another example;

FIG. 5 is a view showing the heat pipe is heated in a heating device;

FIG. 6 is a view showing the heat pipe is supplemented with the working fluid;

FIG. 7 is a view showing the heat pipe after an open end thereof is temporarily sealed;

FIG. 8 is a view showing the working fluid contained in the heat pipe is being pumped out of the heat pipe by a pump;

FIG. 9 is a view showing that the open end of the heat pipe is cramped to be permanently sealed by a tool;

FIG. 10 is a view showing a distal end portion of the open end of the heat pipe is served by a cutter blade;

FIG. 11 is a view showing the sealed open end of the heat pipe is further sealed by soldering;

FIG. 12 is a view similar to FIG. 8, showing the working fluid contained in the heat pipe is being pumped out of the heat pipe in accordance with another example; and

FIG. 13 is a view showing the heat pipe is permanently sealed after the working fluid is pumped out of the heat pipe in accordance with the another example.

### DETAILED DESCRIPTION

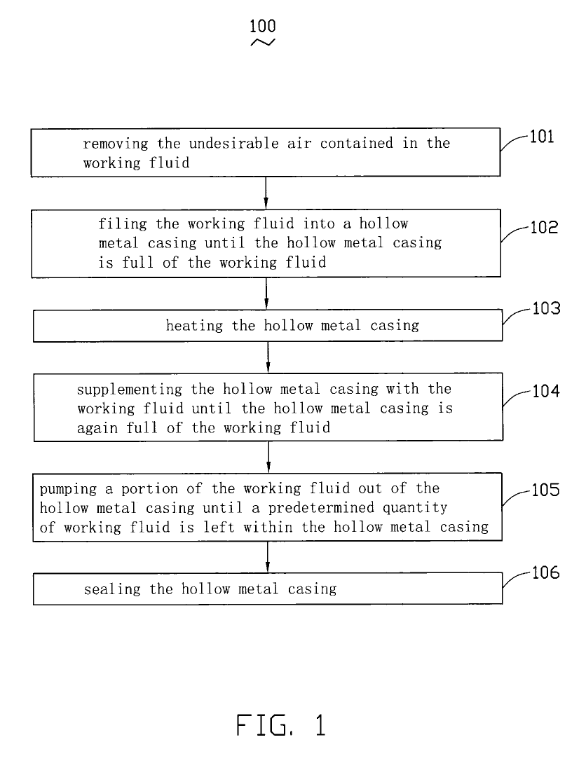

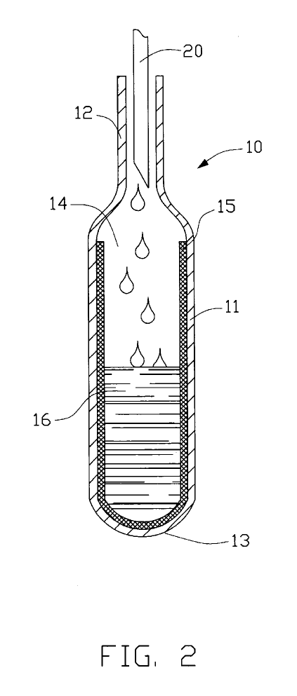

FIG. 1 is a flow chart showing a preferred method 100 of the present invention. The method 100 can be suitably applied for filling and sealing a predetermined quantity of working fluid within a heat pipe or a vapor chamber-based heat spreader or the like, meanwhile maintaining a vacuum condition therein. With reference to FIGS. 2-13, examples of application of the method 100 in the production of a heat pipe 10 are shown. The heat pipe 10 includes a hollow metal casing 11 having an open end 12 and an opposite closed end 13. The open end 12 has a diameter smaller than that of a body (not labeled) of the hollowing metal casing 11. The casing 11 defines therein a chamber 14 in which a wick structure 15 is provided, lining an inner wall of the casing 11. The wick structure 15 for the heat pipe 10 may include fine grooves integrally formed in the inner wall of the casing 11, mesh or bundles of fiber inserted into the casing 11 and held against the inner wall thereof, or sintered powders combined to the inner wall of the casing 11 by a sintering process. The casing 11 is typically made of high thermally conductive material such as copper or aluminum.

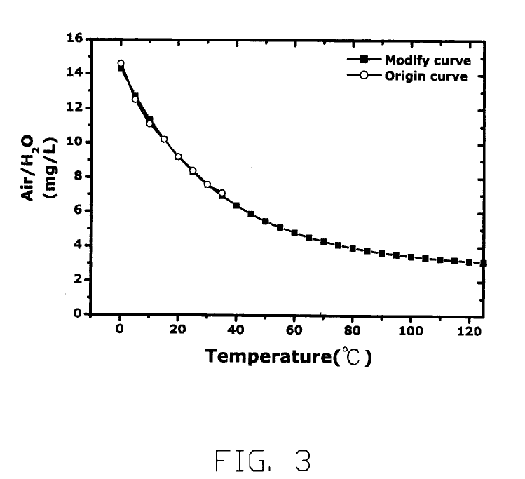

In the heat pipe 10, a working fluid 16 is required. Typically, the working fluid 16 is water, although other liquids such as methanol or the like may also be suitable. Before filled into the heat pipe 10, the working fluid 16 is heated to a boiling temperature thereof so as to extract and remove the undesirable air contained in the working fluid 16 (step 101). FIG. 3 is a graph roughly illustrating the relationship between the temperature and the amount of air contained in water. As can be seen from this figure, a liter of water contains therein about 8.2 milligrams of air at the temperature of 25 degrees Celsius (i.e., room temperature), and about 3.2 milligrams of air at the temperature of 100 degrees Celsius. Therefore, if the working fluid 16 contained in the heat pipe 10 is water, a large amount of undesirable air will be released into the chamber 14 of the heat pipe 10 when the working fluid 16 (water) is heated during normal operations of the heat pipe 10, which will adversely impair the heat transfer effect of the heat pipe 10. In the present method 100, the undesirable air inherently contained in the working fluid 16 is previously eliminated before the working fluid 16 is filled into the heat pipe 10 by heating the working fluid 16 to its boiling temperature. If the working fluid 16 filled into the heat pipe 10 is water, nearly 5 milligrams of air will be removed from per liter of water at this stage.

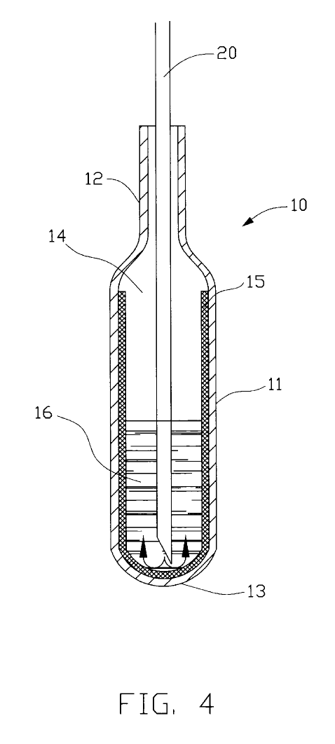

With the undesirable air contained in the working fluid 16 being removed, the working fluid 16 is then filled into the heat pipe 10 through the open end 12 of the casing 11 by using a filling tube 20, until the chamber 14 of the casing 11 is full of the working fluid 16 (step 102), as shown in FIGS. 2 and 4. In FIG. 4, the filling tube 20 extends into an interior of the casing 11 and reaches a position that an outlet (not labeled) of the filing tube 20 is located nearly touching the closed end 13 of the casing 11. In this case, as the working fluid 16 enters the heat pipe 10 in the directions indicated by the arrows as shown, the undesirable air retained in the pores of the wick structure 15 can be advantageously driven out of the casing 11.

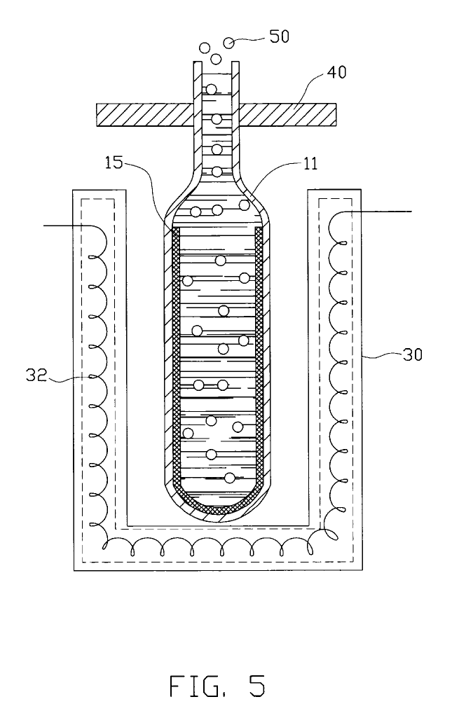

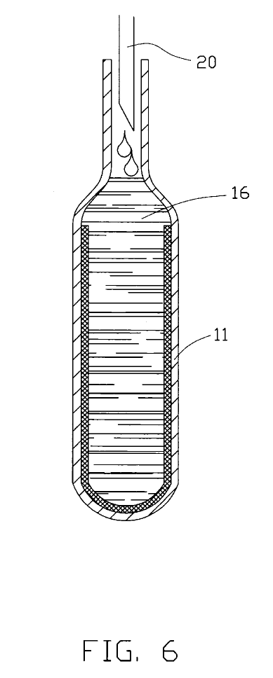

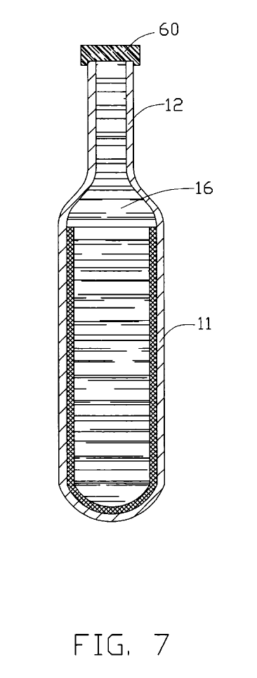

After the chamber 14 of the casing 11 is full of the working fluid 16, the casing 11 is disposed into a heating device 30 in which heating elements 32 are arranged, as shown in FIG. 5. The casing 11 is held in place by a positioning block 40 located near the heating device 30. Electric energy is then supplied to the heating elements 32 to gradually heat the casing 11 whereby the undesirable air contained in the pores of the wick structure 15 is further extracted out of the casing 11 (step 103). The air is shown flowing out of the casing 11 in the form of bubbles 50. Understandably, this step can also achieve the purpose of further extracting the undesirable air contained in the working fluid 16 out of the casing 11, especially if the casing 11 is heated to a temperature near the boiling temperature of the working fluid 16. After this step, a portion of the working fluid 16 contained in the casing 11 will have been evaporated, so it is necessary to supplement the casing 11 with the working fluid 16 until the casing 11 is again full of the working fluid 16 (step 104), as shown in FIG. 6. Thereafter, the open end 12 of the casing 11 is temporarily sealed via an elastic member 60 such as an elastomer or the like so that the interior of the casing 11 is maintained isolated from the ambient air, as shown in FIG. 7.

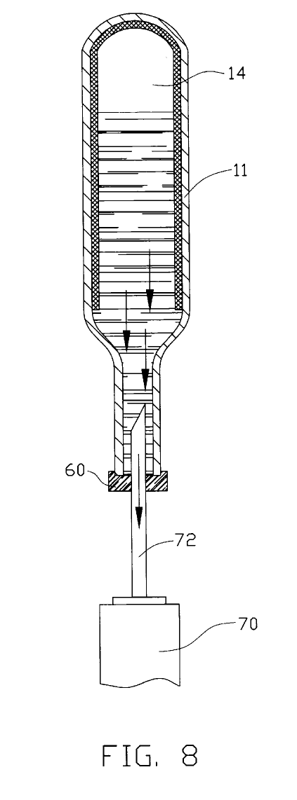

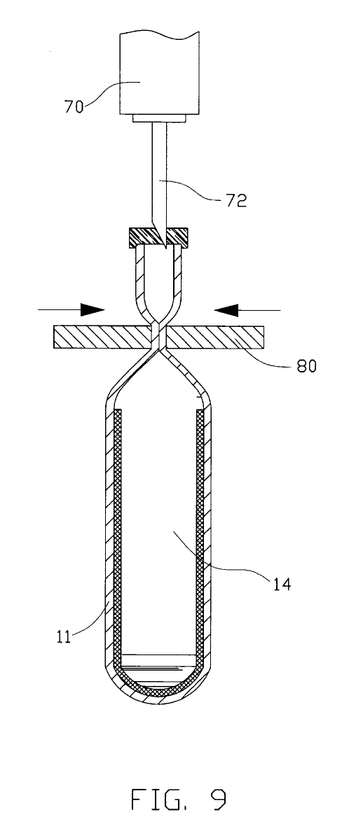

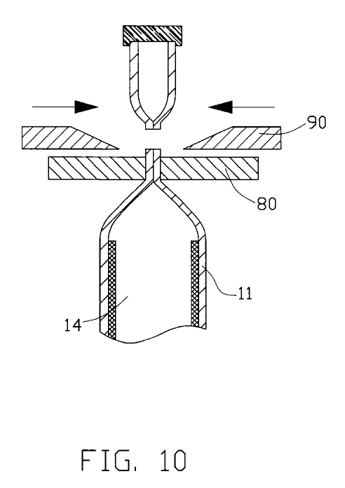

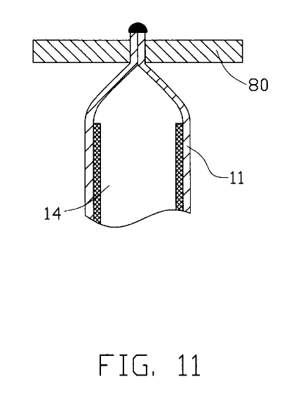

The casing 11 then is placed in an upside-down manner, as shown in FIG. 8, and a suction tube 72 of a pump 70 penetrates through the elastic member 60 and extends into the casing 11. The pump 70 operates to draw a portion of the working fluid 16 out of the casing 11. Since the interior of the casing 11 is isolated from the ambient air by the elastic member 60, a vacuum condition will be formed in the casing 11 after the working fluid 16 is partially removed by the pump 70. The working fluid 16 is pumped out of the casing 11 until a predetermined quantity of working fluid is left within the casing 11 (step 105). Thereafter, the suction tube 72 is drawn out of the casing 11 and the open end 12 of the casing 11 is hermetically sealed (step 106). In this example, a tool 80 is used to mechanically cramp the open end 12 into a flattened sealing section (not labeled), as shown in FIG. 9. A cutter blade 90 is then used to cut a distal end portion of the open end 12 of the casing 11 away and finally the flattened sealing section is soldered to further seal the open end 12 so as to form the heat pipe 10, as shown in FIGS. 10-11.

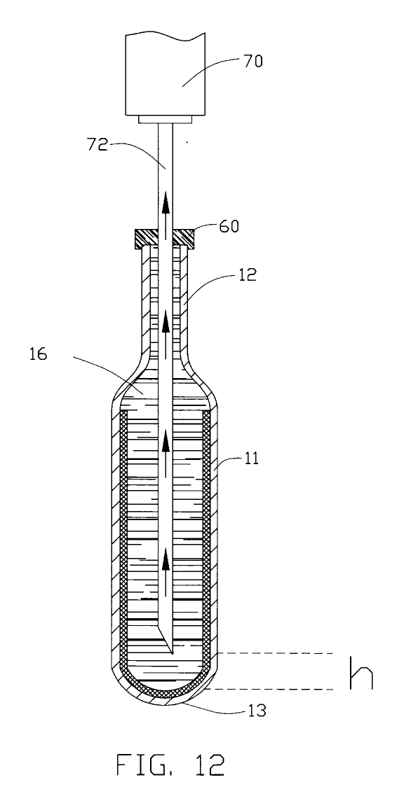

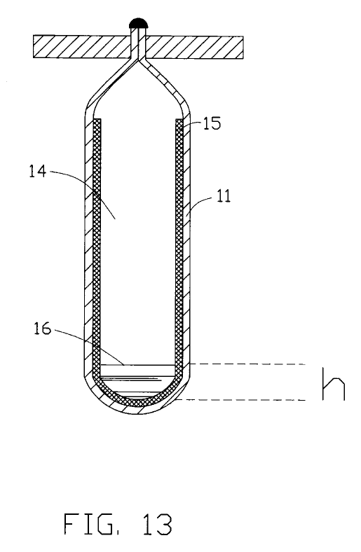

To draw the working fluid 16 out of, and retain the predetermined quantity of working fluid in, the casing 11, the suction tube 72 of the pump 70 may also extend into a large portion of the interior of the casing 11, as shown in FIGS. 12-13. In this situation, a predetermined distance (h) is maintained between a distal free end of the suction tube 72 and the closed end 13 of the casing 11. The predetermined distance is designed according to the amount of working fluid to be left within the casing 11. In this case, the amount of working fluid to be sealed within the casing 11 can be precisely determined by controlling the insertion depth of the suction tube 72 in the casing 11. After the excessive working fluid 16 in the casing 11 is removed, the open end 12 of the casing 11 is hermetically sealed in substantially the same way as described above.

In the present method 100, the air contained in the working fluid and the air retained in the pores of the wick structure 15 are previously removed. The vacuum condition in the casing 11 is formed, by pumping the originally filled working fluid 16 out of the casing 11 until the predetermined quantity of working fluid is left therein. As a result, the undesirable air contained in the heat pipe 10, including that in the working fluid 16 and in the wick structure 15, is effectively removed.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of filling and sealing within a hollow metal casing of a heat-dissipating device with a predetermined quantity of working fluid comprising the steps of:
filling a working fluid into the hollow metal casing through an open end thereof until the hollow metal casing is full of the working fluid;
pumping a portion of the working fluid out of the hollow metal casing until the predetermined quantity of working fluid is left in the hollow metal casing; and
sealing the open end of the hollow metal casing.

2. The method of claim 1, further comprising a step of removing air contained in the working fluid before the working fluid is filled into the hollow metal casing.

3. The method of claim 2, wherein removing the air contained in the working fluid includes heating the working fluid.

4. The method of claim 1, further comprising steps of providing a wick structure inside the hollow metal casing and heating the hollow metal casing after the working fluid is filled into the hollow metal casing but before the portion of the working fluid is pumped out of the hollow metal casing.

5. The method of claim 4, further comprising a step of supplementing the hollow metal casing with the working fluid after the hollow metal casing is heated until the hollow metal casing is again full of the working fluid.

6. The method of claim 1, further comprising a step of temporarily sealing the open end of the hollow metal casing before the portion of the working fluid is pumped out of the hollow metal casing.

7. The method of claim 6, wherein the open end of the hollow metal casing is temporarily sealed with an elastic member.

8. The method of claim 1, wherein the portion of the working fluid is pumped out of the hollow metal casing when the hollow metal casing is located in a manner that the open end is directed downwardly.

9. The method of claim 1, wherein the portion of the working fluid is pumped out of the hollow metal casing by extending a suction tube of a pump into the hollow metal casing with a predetermined depth.

10. The method of claim 11 wherein the working fluid is filled into the hollow metal casing by using a filling tube, an outlet of the filling tube being disposed adjacent to a closed end of the hollow metal casing.

11. The method of claim 1, wherein the heat-dissipating device is one of a heat pipe and a vapor chamber-based heat spreader.

12. The method of claim 1, wherein the working fluid is water.

13. A method for forming a heat pipe comprising:
preparing an elongated hollow metal casing having a closed end and a narrow open end, and a wick structure adjacent to an inner wall of the casing;
injecting working fluid into the casing through the open end until the working fluid substantially fill an entire inner space of the casing;
temporarily sealing the open end;
removing a portion of the working fluid out of the casing; and
permanently sealing the open end.

14. The method of claim 13, wherein the temporary sealing of the open end is achieved by inserting an elastic member into the open end.

15. The method of claim 13, wherein during the removal of the portion of the working fluid, the open end is directed downwardly.

16. The method of claim 13 further comprising a step immediately following the step of injecting working fluid:
heating the wick structure and the working fluid.
